(19) United States
(12) Patent Application Publication
(10) Pub. No.: US 2019/0019375 A1
(43) Pub. Date: Jan. 17, 2019

(54) AD HOC CUSTOMIZABLE ELECTRONIC GAMING TABLE

(71) Applicant: Gamblit Gaming, LLC, Glendale, CA (US)

(72) Inventor: Zachary Foley, Los Angeles, CA (US)

(21) Appl. No.: 16/036,925

(22) Filed: Jul. 16, 2018

Related U.S. Application Data
(60) Provisional application No. 62/532,942, filed on Jul. 14, 2017.

(51) Int. Cl. G07F 17/32; A63F 3/00; G06Q 40/02; G06Q 20/10

(52) U.S. Cl. CPC G07F 17/3244; G07F 17/3276; G06Q 20/10; A63F 3/00157; G06Q 40/025; G07F 17/3295

(57) ABSTRACT

An ad hoc customizable electronic gaming table is disclosed. The ad hoc customizable electronic gaming table includes an electronic gaming table controller, at least one display operatively coupled to the electronic gaming table controller, an NFC tag operably connected to the gaming table controller and operable to communicate with a player device, and a customization server constructed to communicate with the electronic utilizes one-time URLs to coordinate customization of a game state display by a player using the NFC tag as an interface to the player's own player device.

### CROSS REFERENCE TO RELATED APPLICATION

This application claims the benefit of U.S. Provisional Application No. 62/532942, filed Jul. 14, 2017, the contents of which are incorporated by reference herein.

### FIELD OF THE INVENTION

Embodiments of the invention are generally related to data processing systems. More particularly, embodiments of the invention relate to data processing systems that communicate and process wagering data.

### BACKGROUND

The gaming industry has traditionally developed data processing systems such as electronic gaming machines (EGMs) that implement simple wagering processes. However, more complicated wagering processes need data processing systems that are better suited for implementing these more complicated wagering processes. Various aspects of embodiments of the invention meet such a need.

### SUMMARY OF THE INVENTION

Systems and methods in accordance with embodiments of the invention provide a communication and data processing system constructed for an ad hoc customizable electronic gaming table.

In one embodiment, an ad hoc customizable electronic gaming table includes an electronic gaming table controller, at least one display operatively coupled to the electronic gaming table controller, an NFC tag operably connected to the gaming table controller and operable to communicate with a player device, and a customization server constructed to communicate with the electronic gaming table controller. The electronic gaming table controller is constructed to request a one-time use URL from the customization server, communicate the one-time use URL to the NFC tag, receive customization data from the customization server via the network, generate a customized display using the customization data, and display the customized display using the at least one display. The NFC tag is constructed to receive the one-time use URL from the EGT controller and communicate the one-time use URL to a player device. The customization server is constructed to generate the one-time use URL, communicate the one-time use URL to the electronic gaming table controller, receive a communication from the player device that uses the one-time URL to connect to the customization server via a network, engage in a customization dialog with the player device whereby a player may set customization features of the ad hoc customizable electronic gaming table, and communicate the customization data of the customization features to the electronic gaming table controller.

In another embodiments, the electronic gaming table controller and the customization server are constructed from the same device.

In another embodiment, the ad hoc customizable electronic gaming table includes an electronic gaming table controller, at least one NFC tag operably connected to the gaming table controller and operable to communicate with a player device, wherein the NFC tag is constructed to receive a one-time use URL from the EGT controller, and communicate the one-time use URL to a player device. The ad hoc customizable electronic gaming table further includes at least one display operatively coupled to the electronic gaming table controller. The electronic gaming table controller includes at least one processor, and a memory operatively coupled to the processor, wherein the memory stores processor-executable instructions that when executed by the at least one processor cause the at least one processor to generate the one-time use URL, communicate the one-time use URL to the NFC tag, receive a communication from the player device that uses the one-time URL to connect to the electronic gaming table controller via a network, engage in a customization dialog with the player device whereby a player may set customization features of the ad hoc customizable electronic gaming table, generate a customized display based on the customization dialog, and display the customized display using the at least one display.

### BRIEF DESCRIPTION OF THE DRAWINGS

FIG. 1A is a systems diagram of an ad hoc customizable electronic gaming table in accordance with various embodiments of the invention.

FIG. 1B is an illustration of a physical arrangement of an ad hoc customizable electronic gaming table in accordance with various embodiments of the invention.

FIG. 2 is a diagram of a structure of an electronic gaming table controller of an ad hoc customizable electronic gaming table in accordance with various embodiments of the invention.

FIG. 3 is a diagram of a structure of a customization server of an ad hoc customizable electronic gaming table in accordance with various embodiments of the invention.

FIG. 4 is a sequence diagram of interactions between components of an ad hoc customizable electronic gaming table in accordance with various embodiments of the invention.

FIG. 5 is an illustration of an ad hoc customization user interface of an ad hoc customizable electronic gaming table in accordance with various embodiments of the invention.

FIG. 6 is an illustration of a customized display of an ad hoc customizable electronic gaming table in accordance with various embodiments of the invention.

### DETAILED DESCRIPTION

In some embodiments, an electronic gaming table controller provides a wagering user interface that is used to receive commands and display data for a wagering process and wagering outcome in accordance with an interactive wagering proposition. Many different types of interactive wagering processes may be implemented by the ad hoc customizable electronic gaming table.

In some embodiments, the interactive wagering process includes a skill-based game and the ad hoc customizable electronic gaming table detects a player's skillful interactions with an interactive user interface of the ad hoc customizable electronic gaming table.

In accordance with some embodiments, a chance-based component of the interactive wagering proposition can influence interactive elements of the ad hoc customizable electronic gaming table such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, wagers in accordance with the interactive wagering proposition may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In some embodiments, credits can be one or more credits in the form of chips issued and redeemed by an operator or the ad hoc customizable electronic gaming table.

In several embodiments, a player's interaction with the interactive elements of the ad hoc customizable electronic gaming table, application credits can be optionally consumed and/or accrued within the ad hoc customizable electronic gaming table as a result of interaction with the interactive elements. Application credits can be in the form of, but not limited to, application environment credits, experience points, and points generally.

In various embodiments, application credits are awarded on the basis of skillful interactions with the interactive elements of the ad hoc customizable electronic gaming table. The ad hoc customizable electronic gaming table can have one or more scoring criteria, embedded within an electronic gaming table controller that provides the interactive wagering proposition, that can be used to determine player performance against one or more goals of the ad hoc customizable electronic gaming table in accordance with the interactive wagering proposition.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, an interactive wagering proposition includes a wager of application credits for payout of application credits, interactive application elements, and/or interactive application objects in accordance with the chance-based proposition.

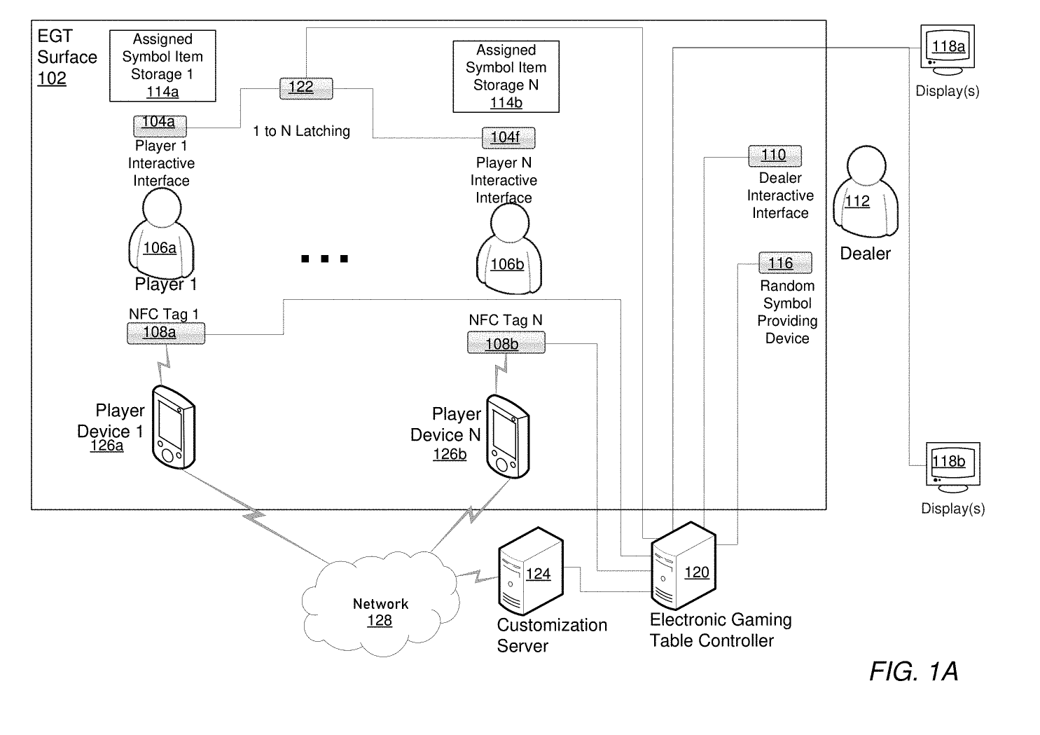

FIG. 1A is a diagram of a structure of an ad hoc customizable electronic gaming table in accordance with various embodiments of the invention. FIG. 1B is an illustration of a physical arrangement of an ad hoc customizable electronic gaming table in accordance with various embodiments of the invention. Referring now to both FIGS. 1A and 1B, an ad hoc customizable electronic gaming table 100 includes a playing surface 102 having one or more player interactive interface devices 104a, 104b, 104c, 104d, 104e, and 104f, that are associated with one or more players, 106a and 106b. The playing surface also includes one or more near field communication (NFC) interfaces or tags, 108a and 108b, that are associated with one or more player positions of the playing surface. The playing surface 102 also has a dealer interactive interface device 110 associated with a dealer 112. The playing surface 102 includes one or more assigned symbol item storage locations, 114a and 114b that are associated with the one or more players 106a and 106b. A random symbol storage device 116 is located on the playing surface 102 in a location accessible to the dealer 112. The ad hoc customizable electronic gaming table includes one or more display devices 118a and 118b used to display game state data of an interactive wagering proposition that is being implemented on the ad hoc customizable electronic gaming table.

The one or more player interactive interface devices 104a, 104b, 104c, 104d, 104e, and 104f, the one or more NFC interfaces 108a and 108b, random symbol item providing device 116, the dealer interactive interface device 110, and the one or more display devices 108a and 108b, are operatively connected to an electronic gaming table controller 120.

The random symbol item providing device 116 is operable to provide one or more randomly determined symbol items to the dealer 112 who in turn places the one or more symbol items in the one or more assigned symbol item storage locations 114a and 114b, associated with the one or more players 106a and 106b. In addition, the random symbol item providing device 116 scans or reads each symbol item as it is provided to the dealer 112 to determine a symbol associated with the symbol item. The random symbol item providing device 116 communicates data of each scanned symbol item to the electronic gaming table controller 120.

In some embodiments, the symbol items are playing cards having symbol indicia printed thereon. The random symbol item providing device 116 scans the symbol indicia using an optical scanner. In many such embodiments, the symbol indicia represent four suits, namely hearts; diamonds; clubs; and spades; and thirteen values, namely ace; king; queen; jack; 10; 9; 8; 7; 6; 5; 4; 3; and 2. In some embodiments, the symbol indicia are printed using fluorescing ink and the cards are illuminated using UV light when they are scanned by the random symbol item providing device 116.

In some embodiments, the symbol items are one or more multi-sided die having symbol indicia on a plurality of external surfaces. The random symbol item providing device 116 scans the symbol indicia using an optical scanner. In some embodiments, the symbol indicia are printed using fluorescing ink and the die are illuminated using UV light when they are scanned by the random symbol item providing device.

Each of the player interactive interfaces 104a to 104f, is operatively connected to the electronic gaming table controller 120. Each player interactive interface 104a to 104f includes at least one visual display device and each player interactive interface 104a to 104f is operable by a player to communicate a player selection of a symbol item to the electronic gaming table controller 120.

In many embodiments, a latching circuit 122 is used to allow only one player's symbol selection to be detected and transmitted to the electronic gaming table controller 120. The latching circuit 122 is operably connected to two or more momentary switches of a respective two or more player interactive interfaces and also operably connected to an electronic gaming table controller 120. In operation, the latching circuit detects a first signal from a player's actuation of a respective momentary switch of the player's respective player interactive interface. The player actuates the momentary switch in order to select a symbol that has been drawn from the random symbol storage device. The latching circuit latches the first signal and transmits the latched signal to the electronic gaming table controller. At the same time, the latching circuit locks out the momentary switches of any other player's respective player interactive interfaces.

In some embodiments, the visual display device of the player interactive interface is an optical output device such as a light emitting diode (LED) or the like. The visual display device receives control signals communicated from the electronic gaming table controller 120 that cause the visual display device to turn on and off, thus emitting light visible to the respective player of the player interactive interface at the command of the electronic gaming table controller.

In some embodiments, the player interactive interface includes a momentary switch operable by the player to indicate their selection of a symbol item to the electronic gaming table controller.

The one or more displays 118a and 188b, are operatively connected to the electronic gaming table controller 120. The electronic gaming table controller 120 determines a game state for an interactive wagering proposition on the basis of data communicated from the one or more player interactive interfaces 104a to 104f, and the random symbol item providing device 116 and generates display data of the game state using the data communicated from the one or more player interactive interfaces and the random symbol item providing device. The electronic gaming table controller 120 communicates the display data to the one or more displays 118a and 118b, and the one or more displays generate a game state display using the display data that is displayed to the one or more players.

In some embodiments, a dealer interactive interface 110 is provided to the dealer 112. The dealer interactive interface 110 is operatively connected to the electronic gaming table controller 120. The dealer interactive interface 110 includes at least one visual display device and is operable by the dealer 112 to communicate dealer interactions with the electronic gaming table to the electronic gaming table controller 120.

In some embodiments, the visual display device is an optical output device such as a light emitting diode (LED) or the like. The visual display device receives control signals communicated from the electronic gaming table controller 120 that cause the visual display device to turn on and off, thus emitting light visible to the dealer 112 at the command of the electronic gaming table controller 120.

In various embodiments, the dealer interactive interface 110 includes input devices such as, but not limited to, buttons or keys; keyboards; keypads; game controllers; joysticks; computer mice; track balls; track buttons; touch pads; touch screens; accelerometers; motion sensors; video input devices; microphones; and the like. In various embodiments, the dealer interactive interface 110 includes output devices such as, but not limited to, audio output devices such as speakers, headphones, earbuds, and the like; visual output devices such as lights, video displays and the like; and tactile devices such as rumble pads, hepatic touch screens, buttons, keys and the like.

In various embodiments, the dealer interactive interface 1110 includes input devices such as, but not limited to, buttons or keys; keyboards; keypads; game controllers; joysticks; computer mice; track balls; track buttons; touch pads; touch screens; accelerometers; motion sensors; video input devices; microphones; and the like. In various embodiments, the dealer interactive interface includes output devices such as, but not limited to, audio output devices such as speakers, headphones, earbuds, and the like; visual output devices such as lights, video displays and the like; and tactile devices such as rumble pads, hepatic touch screens, buttons, keys and the like.

In some embodiments, one or more components an electronic gaming table controller 120 are housed in an enclosure such as a housing, cabinet, casing or the like. The enclosure further includes one or more player accessible openings or surfaces that constructed to mount the user interface input devices and/or the user interface output devices.

In many embodiments, the electronic gaming table controller 120 generates one or more wagering user interfaces used to display wagering data, via one or more of the user interface input and output devices, to one or more players.

In some embodiments, an electronic gaming table controller 120 generates a wagering user interface by executing commands that define processes of the wagering user interface where the commands are formatted in a scripting language. In operation, a wagering user interface generator of the electronic gaming table controller generates commands in the form of a script written in the scripting language. The script includes commands that describe how the electronic gaming table controller is to display wagering outcome data. The electronic gaming table parses the script encoded in the wagering telemetry data and executes the commands included in the script to generate the wagering user interface.

In many embodiments, an electronic gaming table controller 120 generates a wagering user interface based on a document written in a document markup language that includes commands that define processes of the wagering user interface. In operation, a wagering user interface generator of the electronic gaming table controller generates a document composed in the document markup language. The document includes commands that describe how the electronic gaming table controller is to display wagering outcome data. The electronic gaming table controller parses the document and executes the commands encoded into the document to generate the wagering user interface.

In some embodiments, an electronic gaming table controller 120 generates a wagering user interface by executing commands that define processes of the wagering user interface. In operation, a wagering user interface generator of the electronic gaming table controller executes the commands to generate the wagering user interface.

In various embodiments, an electronic gaming table controller 120 includes a data store of graphic and audio display resources that the electronic gaming table controller uses to generate a wagering user interface as described herein.

In many embodiments, the electronic gaming table controller 120 may additionally include various audit logs and activity meters.

The electronic gaming table controller 120 is further connected to a customization server 124. The customization server 124 is further connectable by one or more mobile player devices, such as player device 1 126a and player device N 126b, that are associated with one or more respective players. In many embodiments, the player devices connect to the customization server through a network 128. In some embodiments, the network includes a wide area network (WAN) such as the Internet. In various embodiments, the network is a local area network (LAN). Example player devices include, but are not limited to, smartphones, tablet computers, and the like. In some embodiments, network includes a telephonic network, such as a cellular network, satellite telephone network, or the like. The one or more NFC interfaces 108a and 108b, are wirelessly connectable to the one or more player devices using one or more NFC protocols.

In some embodiments, the customization server 124 and the electronic gaming table controller 120 are constructed from the same device.

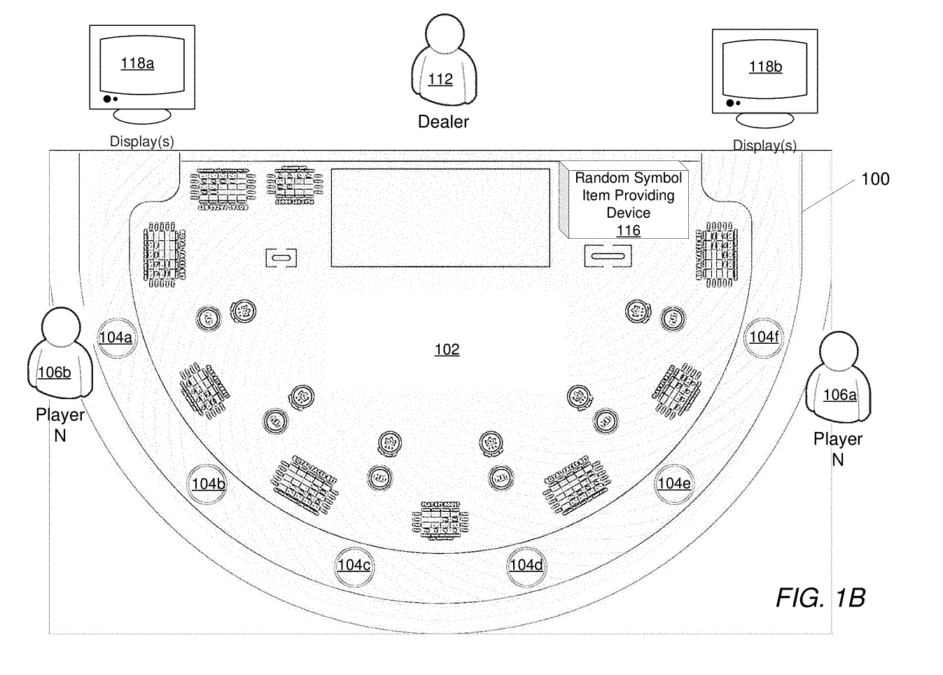

Referring now to FIG. 2, electronic gaming table controller 500 includes a bus 502 that provides an interface for one or more processors 504, random access memory (RAM) 506, read only memory (ROM) 508, machine-readable storage medium 510, one or more player output devices 512, one or more player input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an electronic gaming table controller processing unit 599. In some embodiments, the electronic gaming table controller processing unit includes one or more processors operatively connected to one or more of a RAM, ROM, and machine-readable storage medium; the one or more processors of the electronic gaming table controller processing unit receive instructions stored by the one or more of a RAM, ROM, and machine-readable storage medium via a bus; and the one or more processors execute the received instructions. In some embodiments, the electronic gaming table controller processing unit is an ASIC (Application-Specific Integrated Circuit). In some embodiments, the electronic gaming table controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of player input devices 514 include, but are not limited to: tactile devices including but not limited to, keyboards, keypads, foot pads, touch screens, and/or trackballs; non-contact devices such as audio input devices; motion sensors and motion capture devices that the electronic gaming table controller can use to receive inputs from a player when the player interacts with the electronic gaming table controller; physiological sensors that monitor the physiology of the player; environmental sensors that monitor the physical environment of the electronic gaming table controller; accelerometers that monitor changes in motion of the electronic gaming table controller; and location sensors that monitor the location of the electronic gaming table controller such as global positioning sensors.

The one or more communication interface devices 516 provide one or more wired or wireless interfaces for communicating data and commands between the electronic gaming table controller 500 and other devices that may be included in an ad hoc customizable electronic gaming table. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the electronic gaming table controller, such as but not limited to: an operating system 518; one or more device drivers 522; one or more application programs 520 including but not limited to an interactive application; and ad hoc customizable electronic gaming table electronic gaming table controller instructions and data 524 for use by the one or more processors 504 to provide the features of an electronic gaming table controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the electronic gaming table controller 500 to provide the features of an ad hoc customizable electronic gaming table electronic gaming table controller as described herein

Although the electronic gaming table controller is described herein as being constructed from or configured using one or more processors and instructions stored and executed by hardware components, the electronic gaming table controller can be constructed from or configured using only hardware components in accordance with other embodiments. In addition, although the storage medium 510 is described as being operatively connected to the one or more processors through a bus, those skilled in the art of electronic gaming table controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the player input devices or player output devices can be operatively connected to the one or more processors 504 via one of the communication interface devices 516 or using a communication link.

In various embodiments, the electronic gaming table controller 500 may be used to construct other components of an ad hoc customizable electronic gaming table as described herein, such as a customization server.

In some embodiments, components of an electronic gaming table controller and a customization server of an ad hoc customizable electronic gaming table may be constructed from or configured using a single device using processes that communicate using an interprocess communication protocol. In other such embodiments, the components of an electronic gaming table controller and a customization server of an ad hoc customizable electronic gaming table may communicate by passing messages, parameters or the like.

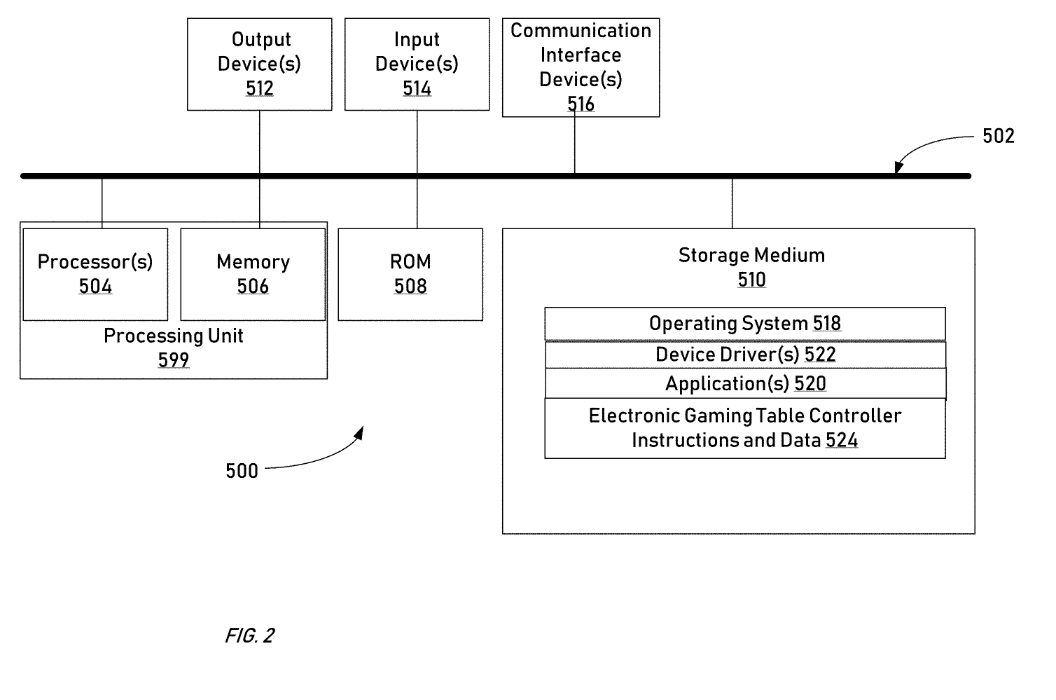

Referring now to FIG. 3, a customization server controller 600 includes a bus 602 that provides an interface for one or more processors 604, random access memory (RAM) 606, read only memory (ROM) 608, machine-readable storage medium 610, one or more player output devices 612, one or more player input devices 614, and one or more communication interface devices 616.

The one or more processors 604 may take many forms, such as, but not limited to: a central processing unit (CPU); a multi-processor unit (MPU); an ARM processor; a controller; a programmable logic device; or the like.

In the example embodiment, the one or more processors 604 and the random access memory (RAM) 606 form a customization server controller processing unit 699. In some embodiments, the customization server controller processing unit includes one or more processors operatively connected to one or more of a RAM, ROM, and machine-readable storage medium; the one or more processors of the customization server controller processing unit receive instructions stored by the one or more of a RAM, ROM, and machine-readable storage medium via a bus; and the one or more processors execute the received instructions. In some embodiments, the customization server controller processing unit is an ASIC (Application-Specific Integrated Circuit). In some embodiments, the customization server controller processing unit is a SoC (System-on-Chip).

Examples of output devices 612 include, but are not limited to, display screens; light panels; and/or lighted displays. In accordance with particular embodiments, the one or more processors 604 are operatively connected to audio output devices such as, but not limited to: speakers; and/or sound amplifiers. In accordance with many of these embodiments, the one or more processors 604 are operatively connected to tactile output devices like vibrators, and/or manipulators.

Examples of player input devices 614 include, but are not limited to: tactile devices including but not limited to, keyboards, keypads, foot pads, touch screens, and/or trackballs; non-contact devices such as audio input devices; motion sensors and motion capture devices that the customization server controller can use to receive inputs from a player when the player interacts with the customization server controller; physiological sensors that monitor the physiology of the player; environmental sensors that monitor the physical environment of the customization server controller; accelerometers that monitor changes in motion of the customization server controller; and location sensors that monitor the location of the customization server controller such as global positioning sensors.

The one or more communication interface devices 616 provide one or more wired or wireless interfaces for communicating data and commands between the customization server controller 500 and other devices that may be included in an ad hoc customizable customization server. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 610 stores machine-executable instructions for various components of the customization server controller, such as but not limited to: an operating system 618; one or more device drivers 622; one or more application programs 620 including but not limited to an interactive application; and ad hoc customizable customization server customization server controller instructions and data 624 for use by the one or more processors 604 to provide the features of a customization server controller as described herein. In some embodiments, the machine-executable instructions further include application control interface/application control interface instructions and data 626 for use by the one or more processors 604 to provide the features of an application control interface/application control interface as described herein.

In various embodiments, the machine-readable storage medium 610 is one of a (or a combination of two or more of) a hard drive, a flash drive, a DVD, a CD, a flash storage, a solid state drive, a ROM, an EIEPROM, and the like.

In operation, the machine-executable instructions are loaded into memory 606 from the machine-readable storage medium 610, the ROM 608 or any other storage location. The respective machine-executable instructions are accessed by the one or more processors 604 via the bus 602, and then executed by the one or more processors 604. Data used by the one or more processors 604 are also stored in memory 606, and the one or more processors 604 access such data during execution of the machine-executable instructions. Execution of the machine-executable instructions causes the one or more processors 604 to control the customization server controller 500 to provide the features of an ad hoc customizable customization server customization server controller as described herein

Although the customization server controller is described herein as being constructed from or configured using one or more processors and instructions stored and executed by hardware components, the customization server controller can be constructed from or configured using only hardware components in accordance with other embodiments. In addition, although the storage medium 610 is described as being operatively connected to the one or more processors through a bus, those skilled in the art of customization server controllers will understand that the storage medium can include removable media such as, but not limited to, a USB memory device, an optical CD ROM, magnetic media such as tape and disks. In some embodiments, the storage medium 610 can be accessed by the one or more processors 604 through one of the communication interface devices 616 or using a communication link. Furthermore, any of the player input devices or player output devices can be operatively connected to the one or more processors 604 via one of the communication interface devices 616 or using a communication link.

In various embodiments, the customization server controller 600 may be used to construct other components of an ad hoc customizable electronic gaming table as described herein.

In some embodiments, components of a customization server controller and a electronic gaming table controller of an ad hoc customizable electronic gaming table may be constructed from or configured using a single device using processes that communicate using an interprocess communication protocol. In other such embodiments, the components of a customization server controller and a electronic gaming table controller of an ad hoc customizable electronic gaming table may communicate by passing messages, parameters or the like.

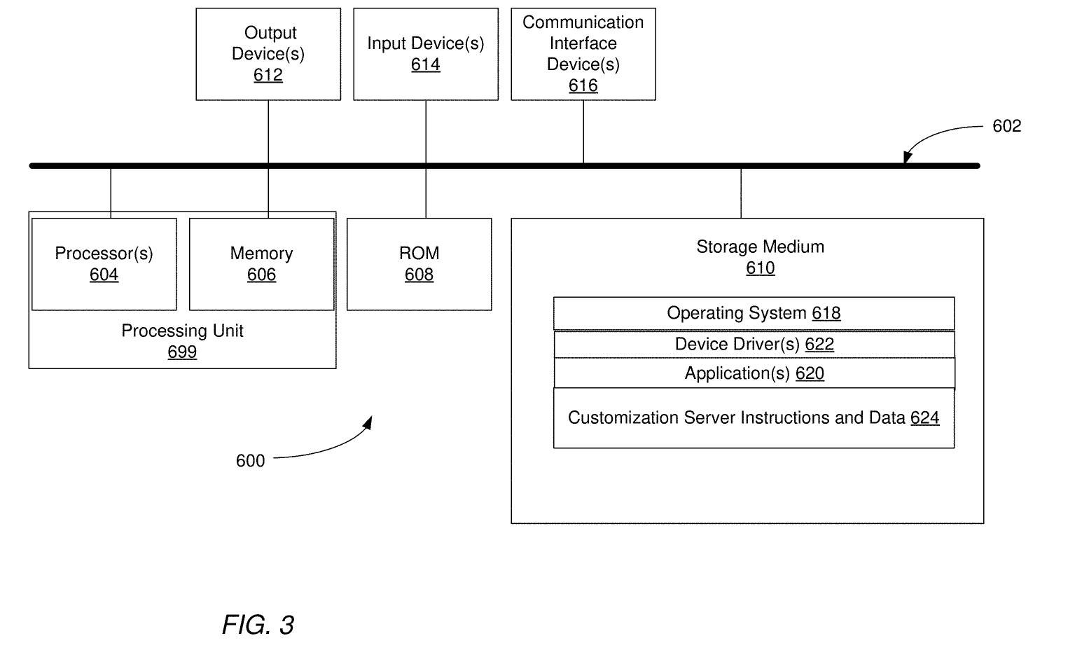

FIG. 4 is a sequence diagram of interactions between components of an ad hoc customizable electronic gaming table in accordance with various embodiments of the invention. The components of the ad hoc customizable electronic gaming table include an electronic gaming table (EGT) controller 700 operably connected to a customization server 702 and operably connected to one or more near field communication (NFC) tags or interfaces 704.

In an initialization process, the EGT controller 700 communicates (706) data of a request for a one-time use uniform resource locator (URL) to the customization server. The customization server receives the data of the request for the one-time use URL and in response generates (708) a one-time use URL.

In various embodiments, the customization server communications using an internet protocol and a one-time use URL is created from a base URL of the customization server and a token created by the customization server. In an example embodiment, the base URL is “example.com” the token is created using a programmatically generated unique identifier and the one-time use URL may be used to access a portion of the customization server, such as by directing a browser to “http://example.com/dialog?token=TOKEN” where “TOKEN” is a string representing the token. In some such embodiments, software components of an ad hoc customizable electronic gaming table are constructed using the Java object orientated programming language. Within Java, a unique id class, UUID, includes methods to generated a unique identifier, such as UUID.randomUUID( ) that may be used as the token. In various embodiments, additional information is added to the token. In some embodiments, a size of a token is reduced by applying a hash function.

The customization server stores (710) the one-time use URL in a data store and communicates (712) data of the one-time use URL to the EGT controller 700. The EGT controller 700 receives the data of the one-time use URL and communicates (714) the data of the one-time use to the NFC tag 704.

In an example embodiment, NFC tags suitable for use are the model NT3H2111 or NT3H2211 NFC Forum Type 2 Tag compliant IC with I2C interface supplied by NXP Semiconductors Netherlands B.V., High Tech Campus 60, 5656 AG Eindhoven, The Netherlands. These NFC tags include an I²C interface that allows them to be programmed by a controller, an NFC silence feature to disable NFC communications, and either a 1K memory (the NT3H2111) or a 2K memory (the NT3H2211) suitable for storage of a one-time use URL.

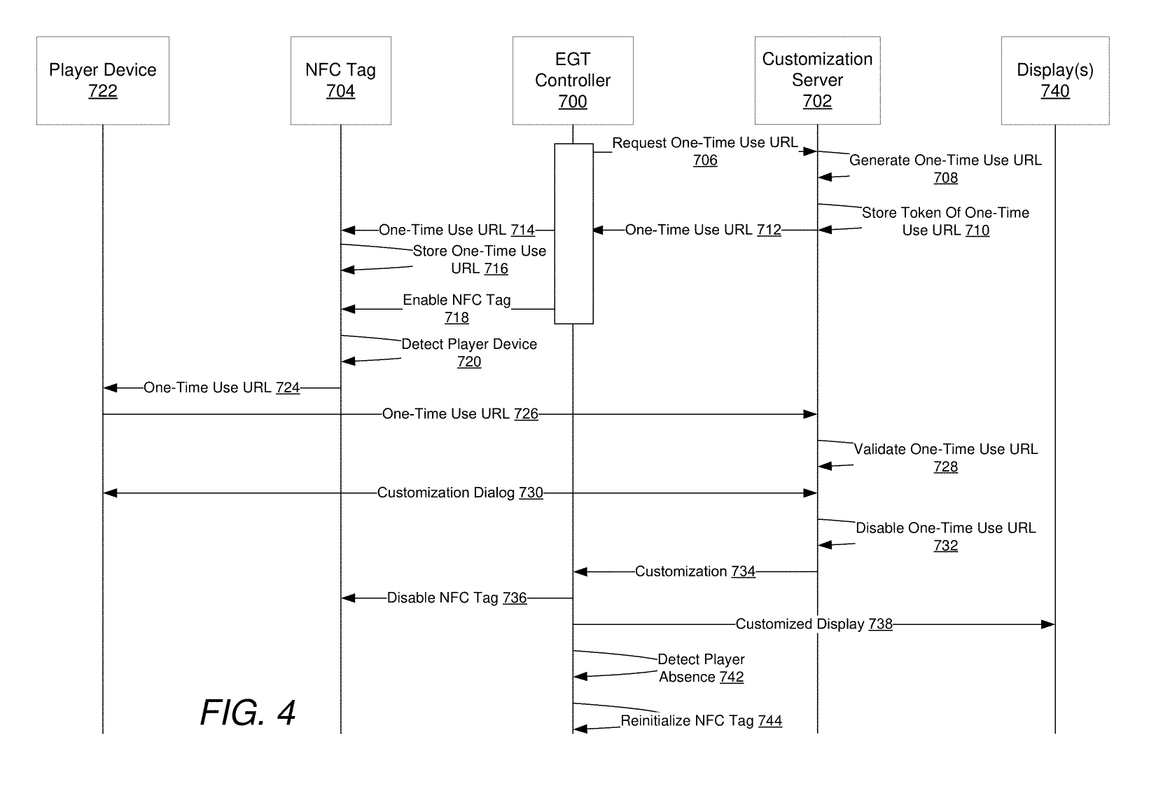

The NFC tag 704 receives the data of the one-time use URL and stores (716) the one-time use URL in a data store. The EGT controller 700 enables (718) the NFC tag 704 to begin communications with nearby devices. When the NFC tag 704 detects (720) a nearby player device 722 capable of utilizing a NFC protocol, the NFC tag 704 communicates (724) data of the one-time use URL to the player device 722. The player device 722 uses the one-time URL to access (726) an ad hoc customization user interface portion of the customization server 702. The customization server 702 validates (728) the token portion of the one-time use URL and engages in a customization dialog 730 with player device whereby a player may set customization features of the ad hoc customizable electronic gaming table. Referring now to FIG. 5, FIG. 5 is an illustration of an ad hoc customization user interface 800 of an ad hoc customizable electronic gaming table in accordance with various embodiments of the invention. An example embodiment of an ad hoc customization user interface is used to set a customization feature of an ad hoc customizable electronic gaming table that is an icon 802 or avatar that represents a player on a display screen of the an ad hoc customizable electronic gaming table. The ad hoc customization user interface is accessible as a web page by a browser of the player device. The ad hoc customization user interface includes a display portion for displaying various avatars for selection by a player and a player name input field 804 for input of a name that the player would like to appear on a display of the ad hoc customizable electronic gaming table. In operation, during a customization dialog, a player selects at least one avatar and enters a player name that will be used by the ad hoc customizable electronic gaming table to customize a display of the ad hoc customizable electronic gaming table.

Referring again to FIG. 4, at an end of a customization dialog, the customization server disables (732) the one-time use URL such as by deleting it from a data store. The customization server communicates (734) data of an ad hoc customization that was performed by the player using the ad hoc customization user interface to the EGT controller 700. The EGT controller 700 receives the data of the customization and disables (736) communicates data of a disable command to the NFC tag 704 such that the NFC tag no longer attempts to communicate with the player device 722. The EGT controller 700 uses the data of the ad hoc customization to generate an ad hoc customized display that the EGT controller displays (738) on one or more display devices 740 of the ad hoc customizable electronic gaming table.

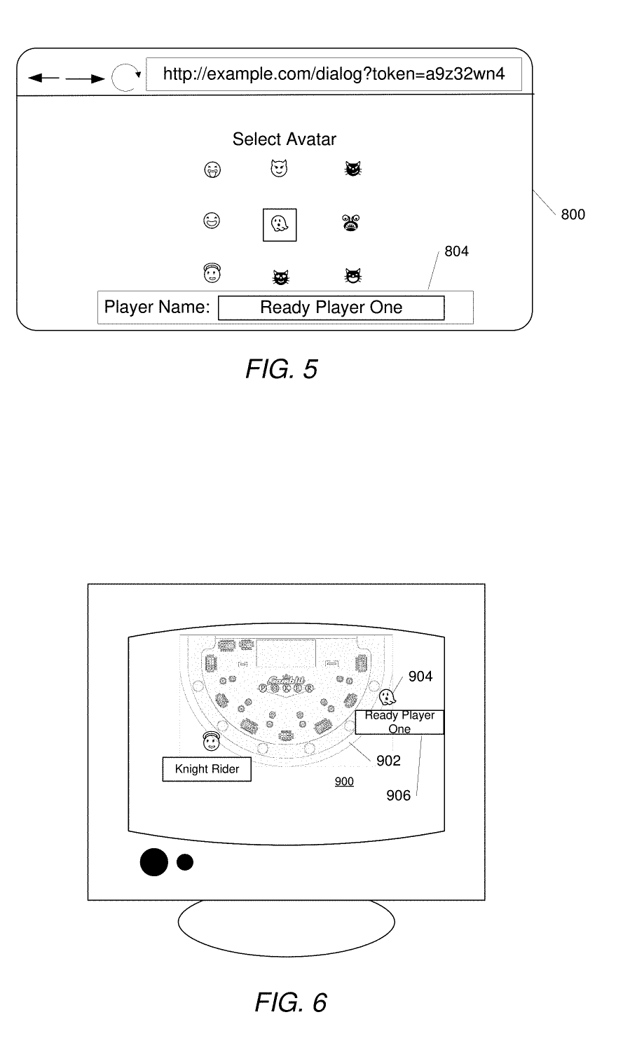

Referring now to FIG. 6, FIG. 6 is an illustration of an ad hoc customized display 900 of an ad hoc customizable electronic gaming table in accordance with various embodiments of the invention. The ad hoc customized display 900 incudes a display portion used to display a facsimile of a playing surface 902 of an ad hoc customizable electronic gaming table having one or more virtual player positions for one or more respective player positions of the ad hoc customizable electronic gaming table. An avatar 904 and a player name 906 are displayed at one or more of the virtual player positions where the avatar and the player name correspond to the data of the avatar and of the player name are included in ad hoc customization data received by the EGT controller from the customization server.

Referring now to FIG. 4, in some embodiments, when the EGT controller 700 detects (742) an absence of the player, the EGT controller reinitializes 744 the NFC tag with a new one-time use URL.

In some embodiments, a player leaves the player device 722 in proximity of the NFC tag 704 such that the player device and the NFC device can continue to communicate, and the EGT controller 700 continuously polls the NFC tag to determine if the player device is still communicatively connected with the NFC tag. If the player device is no longer communicatively connected with the NFC tag, then the EGT controller determines the absence of the player.

In various embodiments, an absence of a player is determined by a dealer and the dealer uses a dealer interface to communicate to the EGT controller 700 that the player is absent such as by leaving the gaming table.

In some embodiments, the EGT controller 700 and the customization server 702 are constructed from the same device.

In various embodiments, the customization features include but are not limited to, an audio clip associated with a player, a player's likeness used as an icon, a video clip associated with the player and to be played when the player wins, and a link to a media stream accessible over a network that is replayed within a display during the player's play.

In some embodiments, the electronic gaming table is a single or multiplayer electronic gaming machine such as a video slot machine or the like.

In some embodiments, the electronic gaming table is for playing a traditional table game, including but not limited to, poker, craps, roulette, or the like.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An ad hoc customizable electronic gaming table, comprising:
an electronic gaming table controller;
at least one display operatively coupled to the electronic gaming table controller;
an NFC tag operably connected to the gaming table controller and operable to communicate with a player device; and
a customization server constructed to communicate with the electronic gaming table controller,
wherein the electronic gaming table controller is constructed to:
request a one-time use URL from the customization server;
communicate the one-time use URL to the NFC tag;
receive customization data from the customization server via the network;
generate a customized display using the customization data; and
display the customized display using the at least one display,
wherein the NFC tag is constructed to:
receive the one-time use URL from the EGT controller; and
communicate the one-time use URL to a player device, and
wherein the customization server is constructed to:
generate the one-time use URL;
communicate the one-time use URL to the electronic gaming table controller;
receive a communication from the player device that uses the one-time URL to connect to the customization server via a network;
engage in a customization dialog with the player device whereby a player may set customization features of the ad hoc customizable electronic gaming table; and
communicate the customization data of the customization features to the electronic gaming table controller.

2. The ad hoc customizable electronic gaming table of claim 1, wherein the electronic gaming table controller and the customization server are constructed from the same device.

3. An ad hoc customizable electronic gaming table, comprising:
an electronic gaming table controller;
at least one NFC tag operably connected to the gaming table controller and operable to communicate with a player device, wherein the NFC tag is constructed to:
receive a one-time use URL from the EGT controller; and
communicate the one-time use URL to a player device; and
at least one display operatively coupled to the electronic gaming table controller,
wherein the electronic gaming table controller comprises:
at least one processor; and
a memory operatively coupled to the processor, wherein the memory stores processor-executable instructions that when executed by the at least one processor cause the at least one processor to:
generate the one-time use URL;
communicate the one-time use URL to the NFC tag;
receive a communication from the player device that uses the one-time URL to connect to the electronic gaming table controller via a network;
engage in a customization dialog with the player device whereby a player may set customization features of the ad hoc customizable electronic gaming table;
generate a customized display based on the customization dialog; and
display the customized display using the at least one display.
